(19) United States
(12) Patent Application Publication
(10) Pub. No.: US 2019/0093358 A1
(43) Pub. Date: Mar. 28, 2019

(54) BRACKETS USING TRAPEZOIDAL METALLIC CONSTRUCTION

(71) Applicant: Pravin Nanayakkara, Boca Raton, FL (US)

(72) Inventor: Pravin Nanayakkara, Boca Raton, FL (US)

(21) Appl. No.: 15/714,901

(22) Filed: Sep. 25, 2017

(51) Int. Cl. E04C 3/02; F16M 13/02; E04B 1/24; E04C 3/04; E04C 3/28; E04B 1/28; E04B 1/16

(52) U.S. Cl. CPC E04C 3/02; F16M 13/02; E04B 1/2403; E04C 3/04; E04C 3/28; E04B 2001/2463; E04B 1/165; E04B 2001/2469; E04B 2001/2415; E04C 2003/0413; E04C 2003/0473; E04B 1/28

(57) ABSTRACT

A construction system definable in terms of an X, Y, and Z coordinate axes which provides a first part having a hollow four-walled web elongate in the Z axis, having a series of securement flaps along the edges of the upper surface of the elongate Z axis member; and a second part having at least one open end for complemental engagement of the first part wherein the second part may fit over distal ends of said first part in which a cross-section of the second part is generally that of the first part, but wide and tall enough to allow the first part to slip within the second part, and said second part having an opposite end of said opening, wherein said second part securing the first part to a structural support.

### BACKGROUND OF THE INVENTION

The present invention relates to metallic surfaces of trapezoids of types used within frame of residential, commercial or industrial structures, and is an improvement of the invention of my U.S. Pat. No. 6,988,347, entitled Metal Stud Frame Element.

Historically frames of such structures were formed of steel and in the case of bearing structures; it was common to use a steel bar.

The use of vertical light gauge steel and studs, in lieu accomplish internal framing within a structure is also well known in the art. It is however not known to employ thin gauge vertical surfaces in combination with exterior wall framing in which vertical studs operate to define an offset the distance between an exterior and which is secured to one surface of such a steel surface.

A need for such surface steel gauges has arisen as a consequence of rapid on-site assembly high techniques employing thin external surfaces which have developed in the construction arts. The present invention therefore relates to such vertical metallic elements in which a one rectilinear surface thereof may operate as a process of an exterior surface, its base and/or load bearing resultant.

### SUMMARY OF THE INVENTION

A construction system definable in terms of an X, Y, and Z coordinate axes which provides a first part having a hollow four-walled web elongate in the Z axis, having a series of securement flaps along the upper XZ base of the elongate Z axis member; and a second part having at least one open end for complemental engagement of the first part wherein the second part may fit over distal ends of said first part in which a cross-section of the second part is generally that of the first part, but wide and tall enough to allow the first part to slip within the second part, and said second part having an opposite end of said opening, wherein said second part securing the first part to a structural support.

Further provided is, the first part having a hollow four-walled web having a lower XZ base and an upper XZ base along an elongate Z axis connected by two opposing webs on the YZ planes.

Additionally provided is a channel in said Z axis in the center of said upper XZ base creating a positive and negative X side that extends from the center channel to the YZ web, wherein said positive X and negative X of upper XZ base each have a series of rectangular cut-outs extending in length along the Z axis that extends in width from the edge of the center channel to the upper edge of the web and a series of rigid flaps extending in the positive Y direction of the YZ plane corresponding to said rectangular cut-outs in which a rigid flap begins where the cut-out begins, and has a length equal in the Z axis to that of the corresponding cut-out. Said securement flaps transfer shear force (shear flow) into the concrete it fixes to. Said cut-outs may also be in a range of geometric shapes, including, circular, square, dovetail, rectangular, etc.

Further provided is a series of substantially circumferential holes occurring toward the upper edges of the YZ web where said series of elements existing along the entire Z distance.

Further provided in the system is an XZ cross-section, which may be in the form of a trapezoid, inverted trapezoid, square, rectangle, or similar shape.

Additionally provided are possible structural supporting members attached to the lower XZ surface, which may be in the form of a rod, such as a rebar, plate fastened to the surface, such as a steel plate, with or without steel sidewalls, or ribs in the lower XZ surface.

It is an object of the present invention to provide metallic structural elements which may be used in a vertical or horizontal capacity, including use within walls, ceilings, and roofs.

It is yet another object to provide a four-walled elongate of the above type which can function as an interior to exterior offsets.

It is accordingly an object of the invention to provide for both cast in place and pre-cast members to support concrete surfaces, such as a floor, roof, or wall.

It is yet another object to provide a four-walled member, capable of being rolled into shape, and cut to a desired length.

It is yet a further object to provide a multi-part system where a second part may complementally engage a first part, and allow the first part to be cut to a desired length as above.

The above and yet other objects and advantages of the invention will become apparent from the hereinafter set forth Brief Description of the Drawings, Detailed Description of the Invention, and Claims appended herewith.

### BRIEF DESCRIPTION OF THE DRAWINGS

FIG. 1 is a perspective view of a first part of the system including a series of rigid securement flaps.

FIG. 2 is a perspective view of a second part of the system of FIG. 1.

FIG. 3 is an XY cross-sectional view of FIG. 4 at 3-3

FIG. 3A is an XY cross-sectional view of FIG. 4 at 3A-3A

FIG. 4 is a side elevation depicting the insertion of the first part within a second part of the system.

FIG. 5 is a YZ elevation view of the system in FIG. 5

FIG. 6 is an XZ top view of the system in FIG. 5

FIG. 7 shows XY trapezoidal cross-sections of the system.

FIG. 8 shows XY square cross-sections of the system.

FIG. 9 shows XY rectangular cross-sections of the system.

FIG. 10 shows other trapezoidal cross-sections of the system.

FIG. 11 shows inverted XY trapezoidal cross-sections of the system.

FIG. 12 is a perspective view of multiple members in the system.

FIG. 13 is an XY cross sectional view of the system of FIG. 12 with form-board.

FIG. 14 is an additional XY cross sectional view of the system of FIG. 13 with form-board removed.

FIG. 15 is an YZ side elevation depicting the full joist of the system.

FIG. 16 is a perspective view of a modified first part of the system.

FIG. 17 is a perspective view of a second part of the system of FIG. 16.

FIG. 18 is an XY cross-sectional view of FIG. 19 at 3-3

FIG. 18A is an XY cross-sectional view of FIG. 19 at 3A-3A

FIG. 19 is a side elevation depicting the insertion of the modified first part within a second part of the system.

FIG. 20 is a YZ elevation view of the system in FIG. 16

FIG. 21 is an XZ top view of the system in FIG. 16

FIG. 22 shows XY trapezoidal cross-sections of the system of FIG. 16.

FIG. 23 shows XY square cross-sections of the system of FIG. 16.

FIG. 24 shows XY rectangular cross-sections of the system of FIG. 16.

FIG. 25 shows another trapezoidal cross-sections of the system of FIG. 16.

FIG. 26 shows inverted XY trapezoidal cross-sections of the system of FIG. 16.

FIG. 27 is a perspective view of multiple members in the system of FIG. 16.

FIG. 28 is an XY cross sectional view of the system of FIG. 27 with form-board.

FIG. 29 is an additional XY cross sectional view of the system of FIG. 28 with form-board removed.

### DETAILED DESCRIPTION OF THE INVENTION

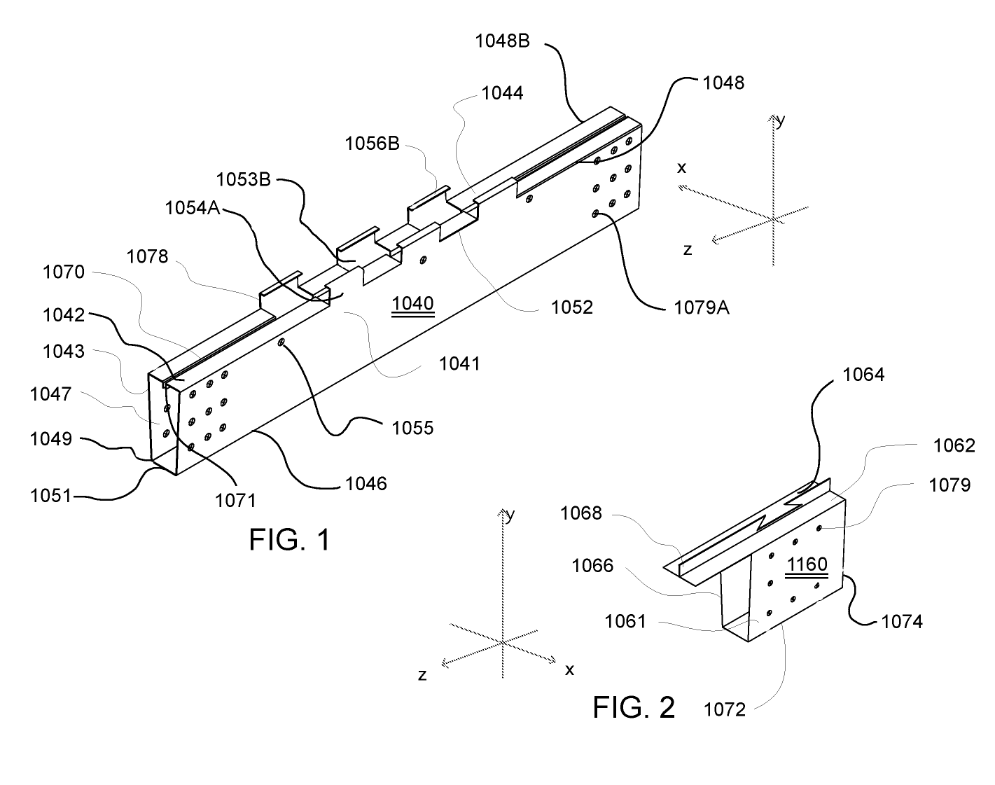

There is provided a construction system which provides terms of an X, Y and Z coordinate system, this particularly as is shown with FIGS. 1, 2, 3, 3A and 4 herewith.

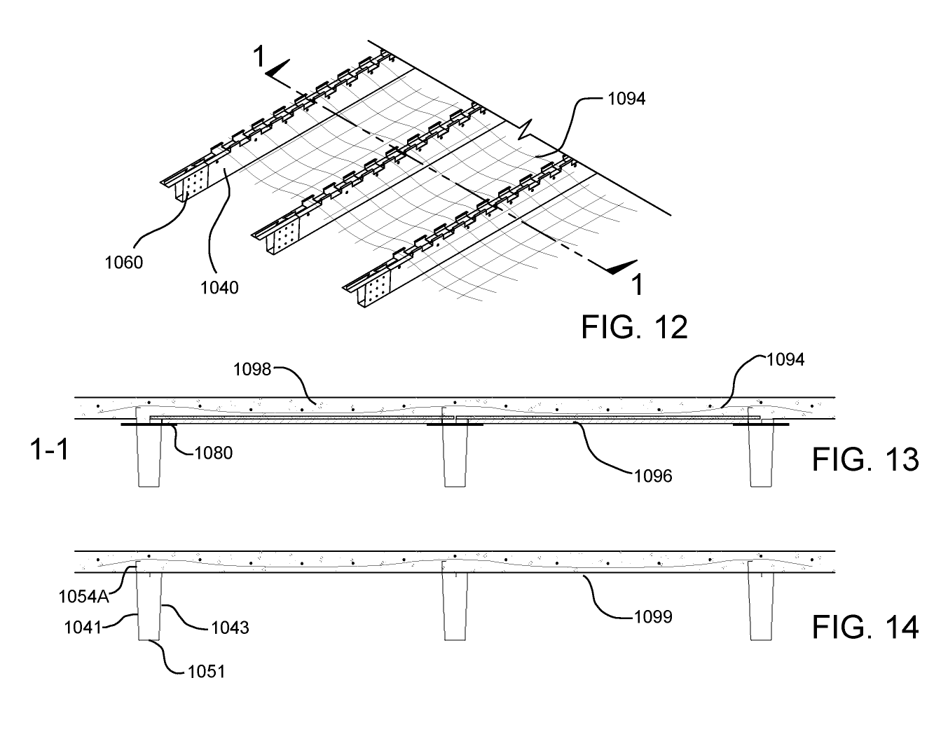

The system may be used in a horizontal orientation in use, for example, with flooring, ceilings, or roofing, and may be produced using material, such as steel, fiber glass, carbon fiber, etc. The system may also be used vertically, for example, in wall construction. One may secure the members 1040 and 1060 in use with concrete or similar material by fitting an opening 1074 of a second part of the system 1060 over a cross-sectional end 1047 of a first part of the system 1040 at each distal end, and casting the concrete as shown in FIGS. 12-14 over a series of securement flaps 1054A/1056A and 1054B/1056B. A securing member 1080, may pass through the members to hold up a material thereof supporting said concrete for cast-in-place uses as shown in FIG. 13. Said securement flaps 1054A/1056A and 1054B/1056B transfer shear force (shear flow) into the concrete it fixes to

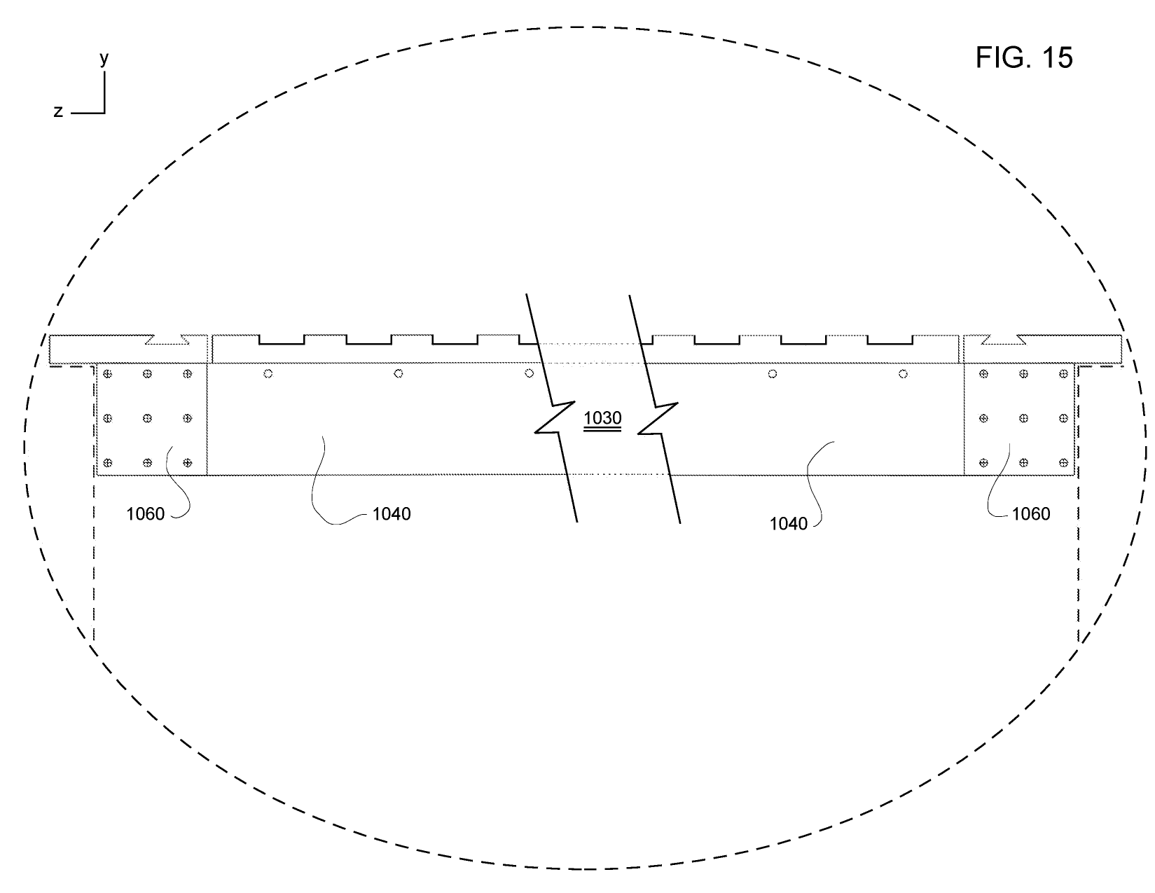

In other words, end members 1060 are placed at each end of the four-walled member. The end member 1060 allows the joists 1030, made up of the first part 1040 and second part 1060, as shown in FIG. 15, to sit on the surface of a structural support, such as a pier, beam, joist, stud, or wall. Once joist members 1030 are placed into their location, a form-work support pin 1080 is placed, and form board 1096 is placed on top of the pins. See FIG. 13. From there a wire mesh 1094 is laid on top of the form board 1096, as shown in FIGS. 12 and 13. From there, concrete 1098 is poured over top of the form board, and once hardened, the pins 1080 can be removed and the form board 1096 lowered, exposing the newly hardened concrete lower surface 1099, as seen in FIG. 14, Supported by the four-walled members.

In FIG. 1 is seen sidewall 1041, on a YZ plane, between edges 1046 of a lower XZ base and 1048 of an upper XZ base. Edges 1046 and 1049 define the lower four-sided XZ base 1051. An upper XZ base is made up of walls 1042 and 1044 and separated in to two halves by channel 1070 The four-walled member is elongate of cross-sectional opening 1047 along a Z axis.

Further shown in FIG. 1, is a series of substantially circumferential holes 1055 occurring toward the upper edges of the YZ web where said series of holes exist along the entire Z distance. These holes 1055 are used in the placement of a form pin 1080, which can be further seen in FIG. 13.

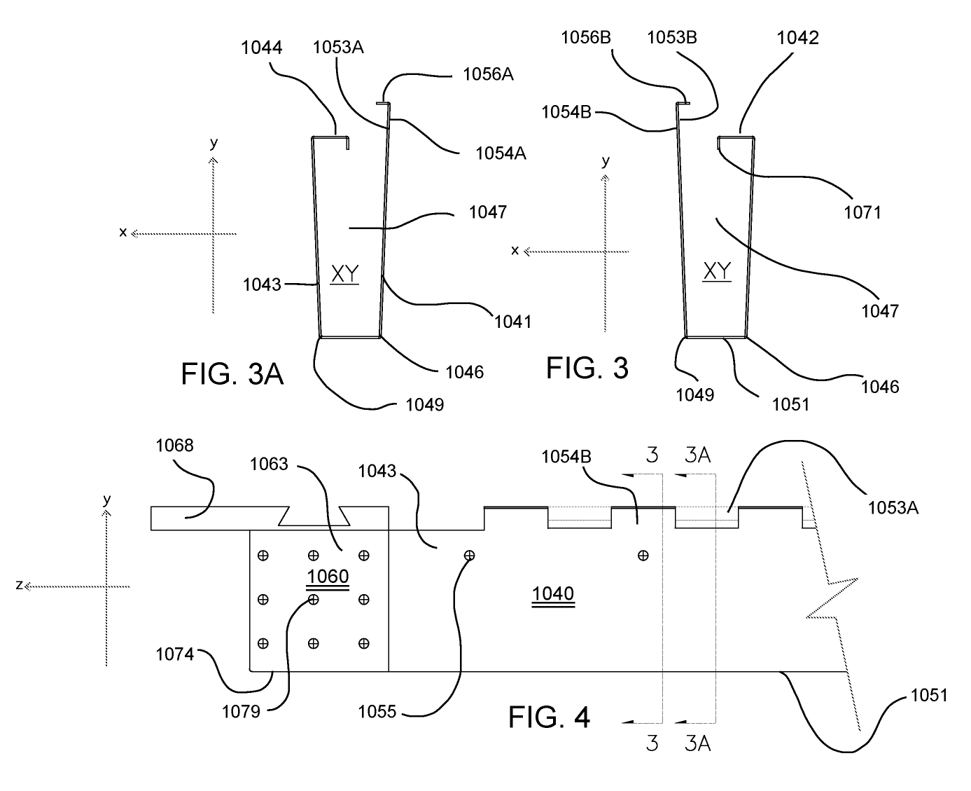

A channel 1070 in said Z axis in the center of said upper XZ base 1042 and 1044 as seen in FIGS. 1 and 6. Channel 1070 further defines the upper XZ base in to positive and negative halves, wall 1044 and wall 1042, each with a lip 1071 in the YZ plane running the length of the channel 1070 and descending in the negative Y direction as seen in FIGS. 1, 3, and 3A. An upper XZ base in which a positive X side 1042 of said channel is different than a negative X side 1044 of said channel, and said upper XZ base on the positive X side 1042 and negative X side 1044 having a vertical lip 1071 extending in the negative Y direction for a sufficient distance and running the length of the channel 1070 on the Z axis.

As may also be seen in FIGS. 1 and 6, the upper XZ base also has rectangular cut-outs that are shown at 1052A and 1052B in FIG. 6. Positive and negative X sides 1042 and 1044 having a series of rectangular cut-outs 1052A and 1052B extending in length along the Z axis that extends in width from the edge of the center channel 1070 to the upper edge 1048 or 1048B, depending on the side, of the web and a series of rigid flaps 1054A and 1054B extending in the positive Y direction of the YZ plane 1041 and 1043 corresponding to said rectangular cut-outs 1052A and 1052B in which rigid flaps 1054A and 1054B begin where the cut-out 1052A and 1052B begin, and have a length equal in the Z axis to that of the corresponding cut-out. Rigid Flaps 1054A and 1054B also having an inner wall 1053A and 1053B thereof. Each rectangular cut-out has a corresponding vertical rigid flap 1054A or 1054B with lip 1056A or 1054B where the length of the cut-out equals the length of the rigid flap, as seen in FIG. 3. Said cut-outs may be in a range of geometric shapes, including, circular, square, dovetail, rectangular, etc.

This is further shown in FIG. 6, where the system can be seen from the top view. The structure further provides said rigid flaps having a cross-section in the YX plane, as shown in FIGS. 3 and 3A, resembling an inverted “L” 1054A and 1056A, or a mirror of an inverted “L” 1054B and 56B, protruding from the upper XZ base in the positive Y direction, where the XZ lip extends towards the direction of the center channel 1070 on the X axis.

In an ideal manufacture, the member 1040 will begin as a continuous solid sheet of metal, and will be rolled into for on a continuous machine, allowing members to be cut into varying lengths.

FIG. 2 is the second part of the system. The member 1060 of the second part slip-fits over the member 1040 of a first part. The member of the second part 1060 is of the same proportions of the first part with a slightly larger cross-section to allow the four-sided entrance 1047 of the first part to slide in to the opening 1074 of the second part. Sidewall 1061 of the second part abuts the outside of sidewall 1041 of the first part. Sidewall 1066 abuts sidewall 43. Lower XZ base 1072 of the second part abuts the underside of lower XZ base 1051 of the first part. Wall 1062 of the second part abuts the outside of wall 1042 of the first part. Wall 1064 of the second part abuts the outside of wall 1044 of the first part. Flange 1068 of the second part will operate and function in the same fashion as flange 1058 of the first part. Areas for screws 1079 exist on the sidewalls if the second part of the system, and complement area 1079A on the first part of the system. Screws allow the first part of the system to fasten to the second part of the system.

FIGS. 3 and 3A shows a cross-sections of FIG. 4 of the first part of the member. Noticed are YZ sidewalls 1043 and 1041, Upper XZ base of walls 1042 and 1044, and lower XZ base 1051. Also shown are rigid flaps 1053A/1056A and 1053B/1056B.

FIG. 4 shows an XZ side elevation of the first and second part of the system of FIGS. 1 and 2, respectively, engaged in a position where the second part is fitted over the first part of the system.

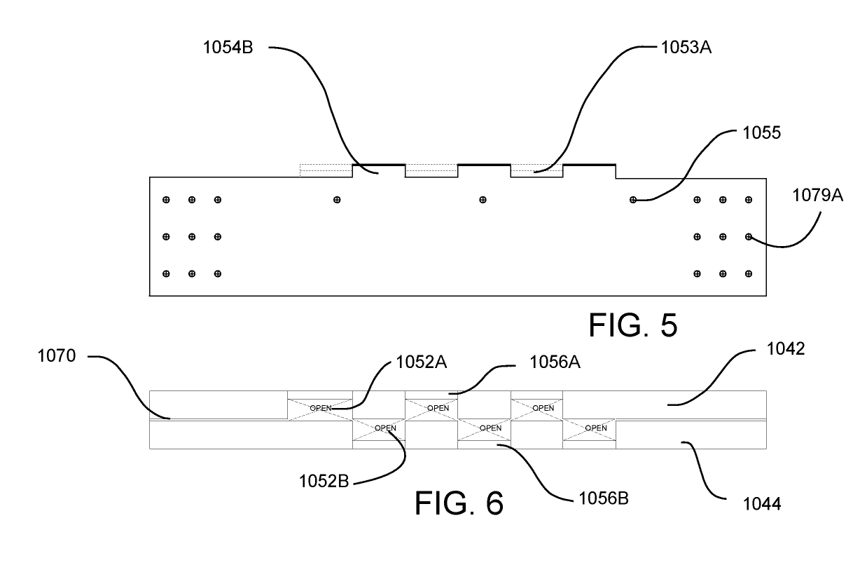

FIG. 5 shows a side elevation of the first part of the system, including views of rigid flaps 1054B, opposing inner rigid flap walls 1053A, holes 1055, and screw areas 1079A.

FIG. 6 shows a top view of the first part of the system, including views of channel 1070, open cut-outs 1052A and 1052B, walls 1042 and 1044 of the upper XZ base, and rigid flap lips 1056A and 1056B.

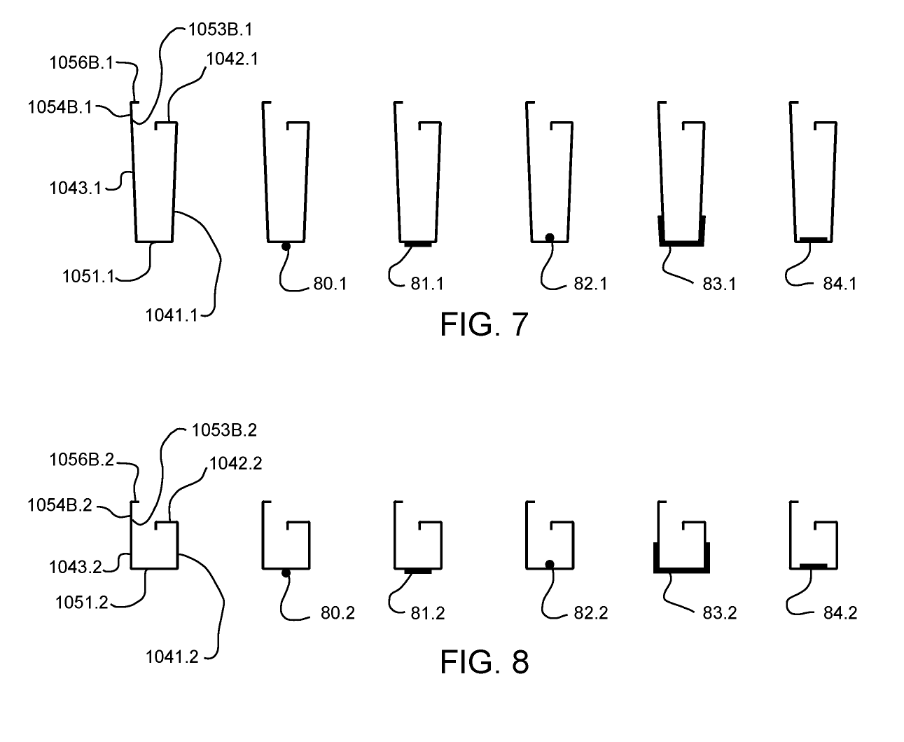

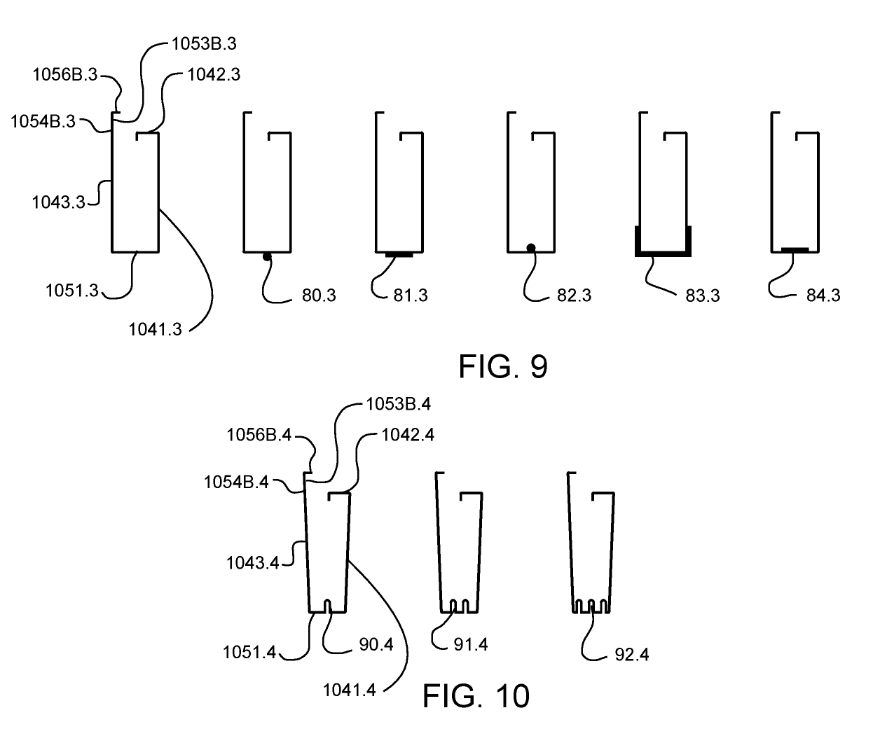

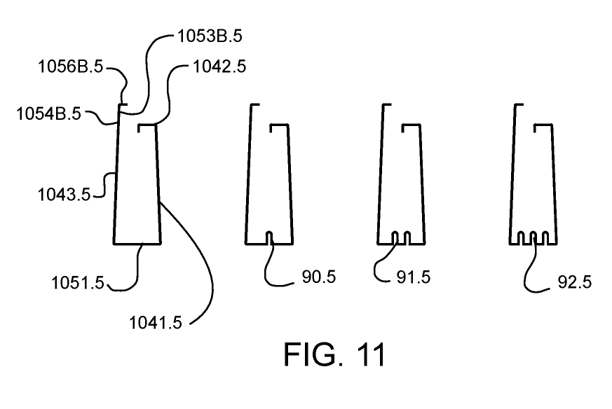

In FIGS. 7-11 are shown different cross sections of the four-walled members. FIG. 7 shows the XY cross-section as a trapezoid with upper XZ base of larger width than lower XZ base. FIG. 8 shows the XY cross-section as a square with upper and lower XZ base of equal width, and right and left sides of equal width to each other as well as upper and lower base. FIG. 9 shows a XY cross-section similar to FIG. 8, but with sidewalls larger in length than in width, resembling that of a rectangle. FIG. 10 is a trapezoidal cross-section similar to FIG. 7. FIG. 11 is similar to the cross section of FIG. 10, but as an inverted trapezoid, having a lower XZ base larger than an upper XZ base.

Additionally shown in FIGS. 7, 8, and 9, are means for increasing the structural strength of the lower XZ base of the four-walled member. As shown in FIG. 7, element 80.1 is a steel rod, similar to rebar, mounted directly to the bottom and elongate in the Z axis of the XZ base of the four-walled member. Similar elements 80.2 and 80.3 can be seen in FIGS. 8 and 9 respectively. Element 81.1 is similar to element 80.1, but is a steel plate elongate in the Z axis and mounted to the under-side of the lower XZ base. Element 82.2 is a steel rod, similar to element, but mounted to the inside lower XZ base of the four-walled member. Element 83.1 is a u-shaped, three-walled, steel plate that is secured to the under side of the lower XZ base. Element 84.1 is a steel plate similar to that of 81.1, in that it is elongate in the Z axis, but is fastened to the inside lower XZ base of the four-walled member.

Each of these structural securements in FIG. 7 are presenet in the embodiments in FIGS. 8 and 9, that is, element 80.1 corresponds with elements 80.2 and 80.3. Element 81.1 corresponds with elements 81.2 and 81.3. Element 82.1 corresponds with elements 82.2 and 82.3. Element 83.1 corresponds with elements 83.2 and 83.3. Element 84.1 corresponds with elements 84.2 and 84.3.

Shown in FIGS. 10 and 11, are different variations of ribs, elements 90.4, 91.4, 92.4, 90.5, 91.5, 92.5, that may be shaped within the lower XZ base of the four-walled member. These ribs offer structural securement of the member by increasing the area of the lower XZ base by giving it more surface area to distribute the stresses, which in turn gives the member a higher strength.

FIGS. 12, 13, and 14 show the system in use. FIG. 12 shows several of the four-walled members with a wire mesh 94 over top. FIG. 13 shows a cross-section, 1-1, of the system with support pins 1080 holding up a form boards, and wire mesh 1094 over top of that. FIG. 14 shows how the cross-section will appear once the form pins and form boards are removed, exposing the concrete.

FIG. 15 further shows the system, of a first part 1040 engaging with a second part 1060 and forms a joist, which then sits on a structural support, such as a pier, beam, joist, stud, or wall. The joist forms a side elevation of a widened ‘T’. The sides of the ‘T’ allow the joist to sit on the structural supports. In other words, the second part 1060 has elements opposite of the opening which allow the member 1060 to attach member 1040 to the structural support.

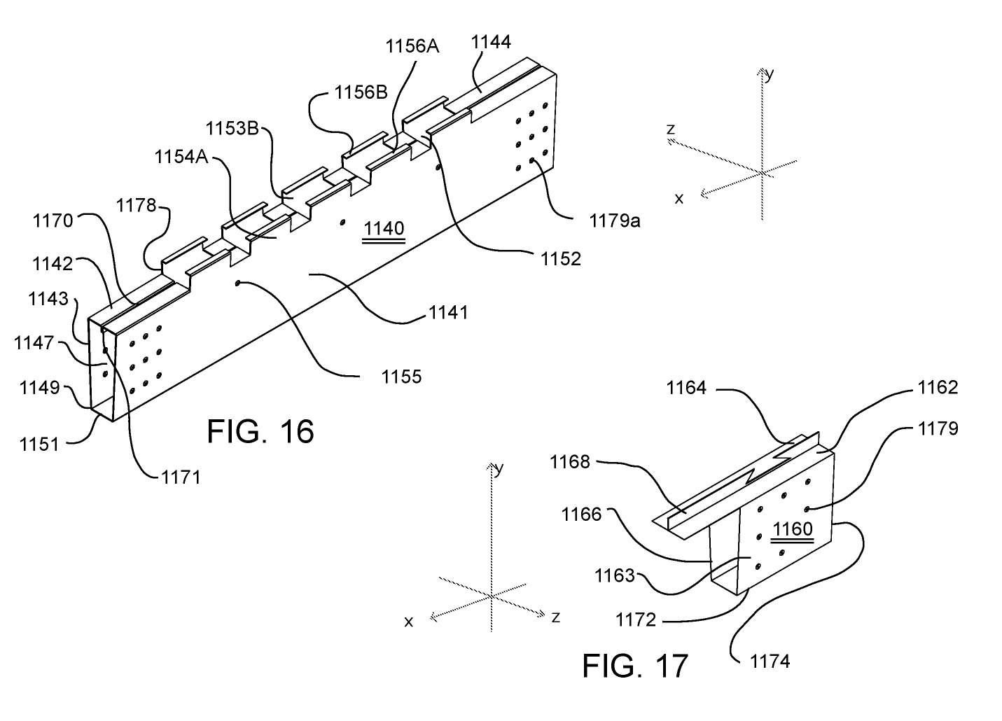

There is provided a second embodiment of a construction system provided in terms of an X, Y, and Z coordinate system. This is particularly shown in FIGS. 16-19.

The primary differences from the first embodiment to the second embodiment are the nature of the rigid flaps. In a first embodiment shown in FIGS. 1 and 6, the rigid flaps occur along the edges of the upper XZ base, and occur in an inverse order. In other words, the series of flaps 1054A will provide a series of an alternating walls 1042 and cut-outs 1052A, in which said cut-outs 1052A will have a corresponding flap 1054A from the edge of the cut-out in rising in the positive Y direction. As such, an opposing side will have series of alternating surfaces 1044 and cut-outs 1052B, in which a cut-out 1052B exists complemental to a wall 1042 on an opposing X side. The second embodiment, shown in FIGS. 16 and 21, comprises flaps similar to that of the first embodiment, but in an orientation in which the flaps and cut-outs mirror a complemental side. In other words, flaps 1154A will occur opposite of flaps 1154B, and cut-outs 1152 on the 1142 side will occur opposite cut-outs 1152 on the 1144 side, and walls 1142 will occur opposite of walls 1144. Said cut-outs may be in a range of geometric shapes, including, circular, square, dovetail, rectangular, etc.

FIG. 16 is a view similar to that of FIG. 1. Edges 1148A and 1148 are seen at an upper YZ plane, while the lowermost edges 1146 and 1149 such with respect of a four-walled member, elongate in the area 1147. The uppermost area is determined by outer walls 1142 and 1144. Also, as may be noted, edges of 1146 and opposite edge 1149 of the cross-section ends in area 1147 and, therefrom, between area of Y, and hollow of upper XY bases and between 1142 and 1144.

In FIG. 17 is seen the second part of the second embodiment, which may be the same as the first embodiment.

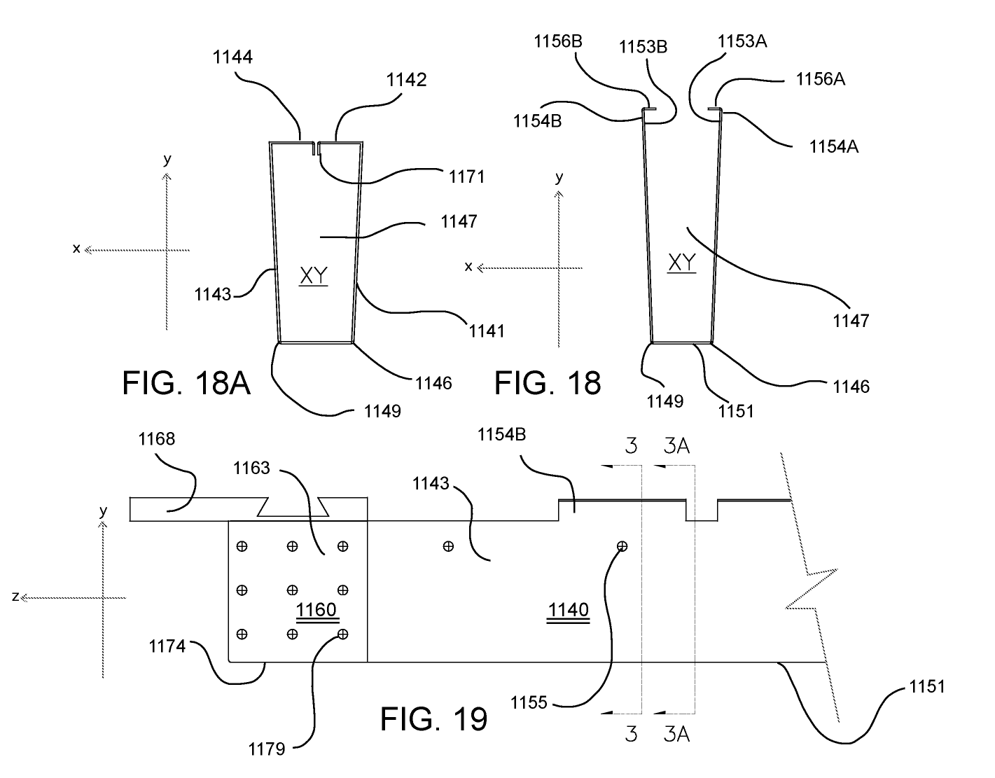

FIGS. 18 and 18A show cross-sections of FIG. 19 of the first part of the member. Noticed are YZ sidewalls 1143 and 1141, Upper XZ base of walls 1142 and 1144, and lower XZ base 1151. Also shown are rigid flaps 1154A/1156A and 1154B/1156B.

FIG. 19 shows a side elevation view of a complemental engagement of a first part within a second part of the system of the second embodiment.

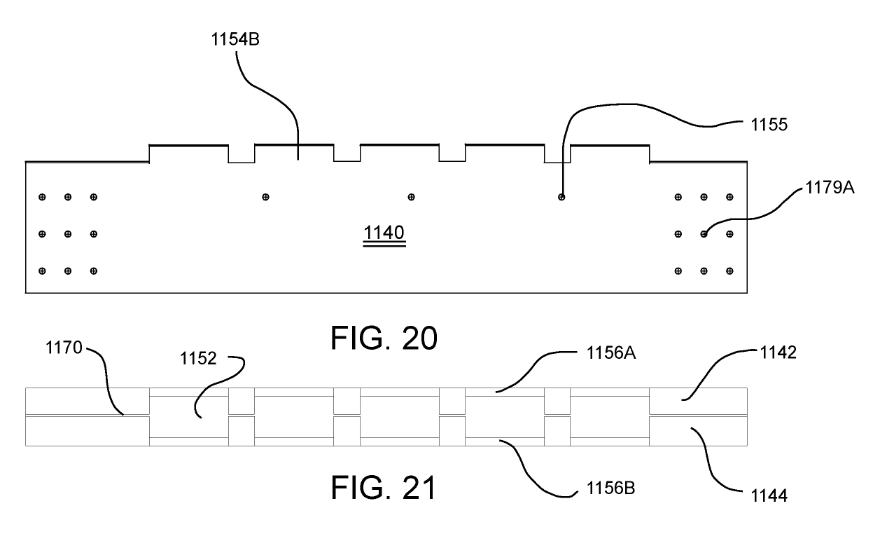

In FIG. 20 is shown side, YZ elevation view of FIG. 16, and includes views of rigid flaps 1154B, opposing holes 1155, and screw areas 1179A.

In FIG. 21 shows a top view of the first part of the system, including views of channel 1170, open cut-outs 1152, walls 1142 and 1144 of the upper XZ base, and rigid flap lips 1156A and 1156B.

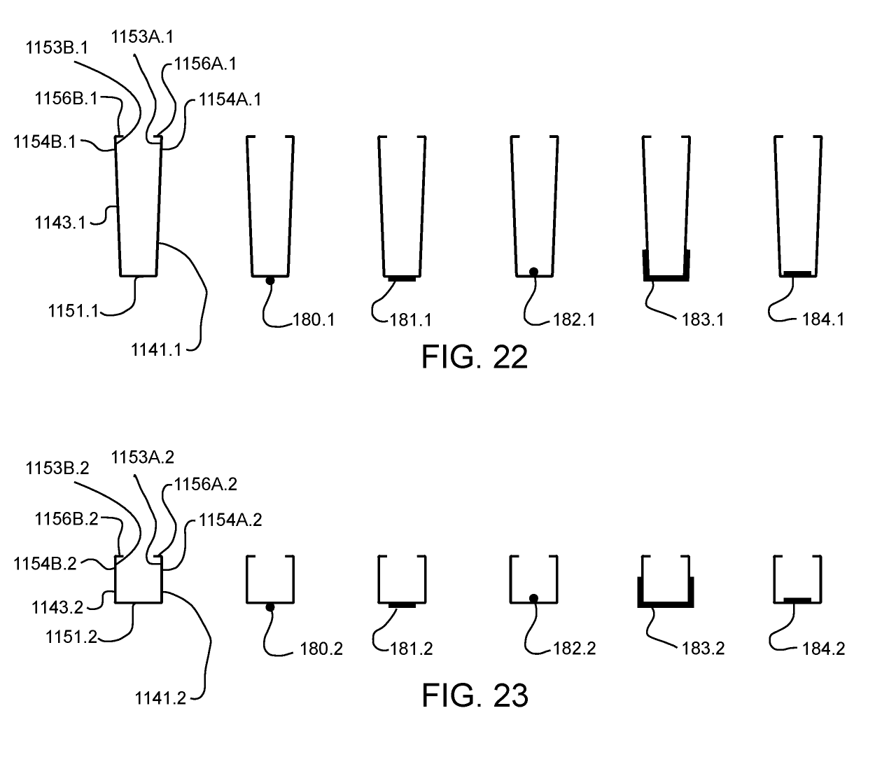

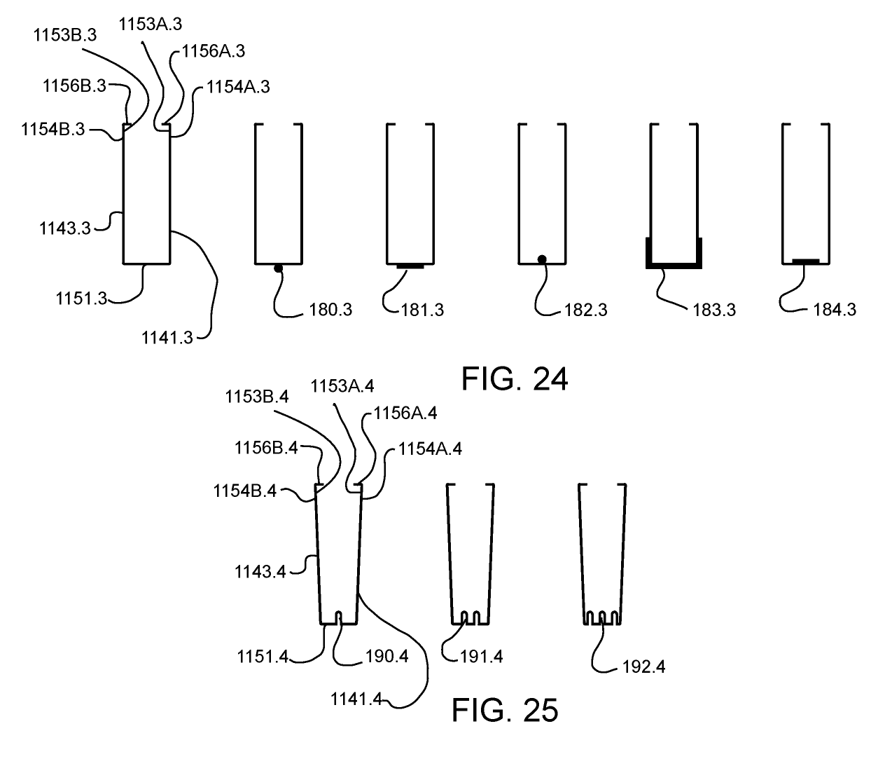

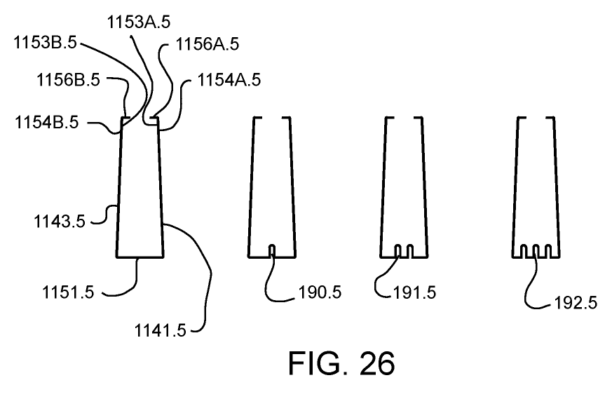

In FIGS. 22, 23, 24, 25, and 26 are shown different cross sections of the four-walled members, similar to FIGS. 7, 8, 9, 10, and 11 of the first embodiment, except for the cross-section of the rigid flaps.

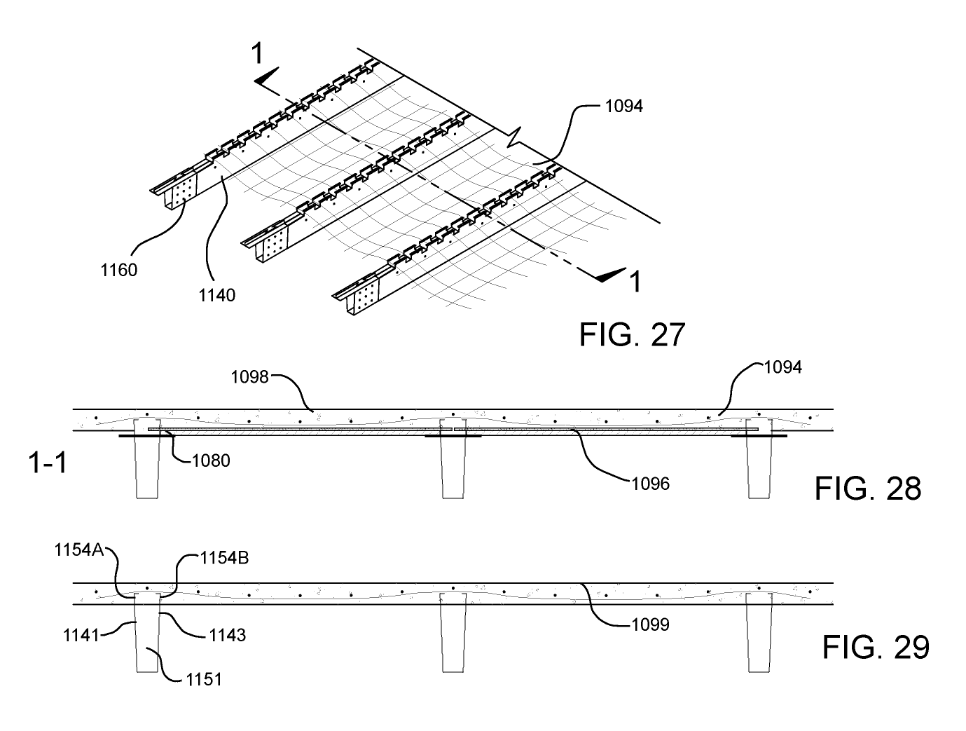

FIGS. 27, 28, and 29 show the system of the second embodiment, which performs the same as the system of the first embodiment depicted in similar FIGS. 12, 13, and 14, except for the nature of the rigid flaps 1154A/1156A and 1154B/1156B. Further see FIGS. 27, 28, and 29 in comparison with FIGS. 12, 13, and 14.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. A construction system definable in terms of an X, Y, and Z coordinate axes structure, the system comprising:
(a) a first part having a hollow four-walled web elongate in the Z axis, having a series of securement flaps on the edges of the upper surface of the elongate Z axis member; and
(b) a second part having at least one open end for complemental engagement of the first part wherein the second part may fit over distal ends of said first part in which a cross-section of the second part is generally that of the first part, but wide and tall enough to allow the first part to slip within the second part, and said second part having an opposite end of said opening, wherein said second part securing the first part to a structural support.

2. The system of claim 1, further comprising:
(c) said first part having a hollow four-walled web having a lower XZ base and an upper XZ base along an elongate Z axis connected by two opposing webs on the YZ planes;
(d) a channel in said Z axis in the center of said upper XZ base creating a positive and negative X side that extends from the center channel to the YZ web;
(e) said upper XZ base on the positive X and negative X side having a vertical lip extending in the negative Y direction for a sufficient distance and running the length of the channel on the Z axis;
(f) said positive X and negative X of upper XZ base each having a series of rectangular cut-outs extending in length along the Z axis that extends in width from the edge of the center channel to the upper edge of the web;
(g) a series of rigid flaps extending in the positive Y direction of the YZ plane corresponding to said rectangular cut-outs in which a rigid flap begins where the cut-out begins, and has a length equal in the Z axis to that of the corresponding cut-out.
(h) said series of rigid flaps having a space between each flap

3. The system in claim 2, further comprising:
said positive and negative cut-outs inversely alternating in opposition to each other; and

4. The system in claim 2, further comprising:
said positive and negative cut-outs existing complementally across from one another.

5. The system in claim 2, further comprising:
said rigid flaps on the positive X having a cross-section in the YX plane resembling an inverted “L”, wherein the lip of the “L” extends towards the direction of the center channel on the X axis; and
said rigid flaps on the negative X having a cross-section in the YX plane resembling a mirror of an inverted “L”, wherein the Hp of the “L” extends towards the direction of the center channel on the X axis.

6. The system as recited in claim 2, wherein said cut-outs and said spaces are square in shape.

7. The system as recited in claim 2, wherein said cut-outs and said spaces are dovetail in shape.

8. The system as recited in claim 2, wherein said cut-outs and said spaces are circular in shape.

9. The system as recited in claim 2, wherein said cut-outs and said spaces are rectangle in shape.

10. The system as recited in claim 5, further comprising:
a series of substantially circumferential holes occurring toward the upper edges of the YZ web; and
said series of elements existing along the entire Z distance.

11. The system as recited in claim 10, further comprising:
an XZ cross-section in the form of a trapezoid; and
said trapezoidal cross-section having an XZ base larger in width than a lower XZ base.

12. The system as recited in claim 11, further comprising:
a structural securing member fastened to the lower XZ surface and elongate in the Z axis.

13. The system as recited in claim 12, comprising:
said securing member comprises a rod secured to the underside of the lower XZ base and elongate in the Z axis.

14. The system as recited in claim 12, comprising:
said securing member comprises a rod secured to the inside surface of the lower XZ base and elongate in the Z axis.

15. The system as recited in claim 12, comprising:
said securing member comprises a steel plate fastened to the under side of the lower XZ base and elongate in the Z axis.

16. The system as recited in claim 12, comprising:
said securing member comprises a steel plate fastened to the inside surface of the lower XZ base and elongate in the Z axis.

17. The system as recited in claim 12, further comprising:
said securing member comprises a steel U-shaped plate fastened to the under side of the lower XZ base and elongate in the Z axis; and
said steel U-shaped plate having a lower XZ base and two side-walls.

18. The system as recited in claim 12, further comprising:
at least one rib in the lower XZ base; and
said at least one rib elongate in the Z axis.

19. The system as recited in claim 10, further comprising:
an XZ cross-section comprising four straight sides and four right angles;
the XZ cross-section where all angles between the sidewalls and the upper base are at a 90 degree angle;
the XZ cross-section where all angles between the sidewalls and the lower base are at a 90 degree angle;

20. The system as recited in claim 19, further comprising:
a structural securing member fastened to the lower XZ surface and elongate in the Z axis.

21. The system as recited in claim 20, further comprising:
said securing member comprises a rod secured to the under side of the lower XZ base and elongate in the Z axis.

22. The system as recited in claim 20, further comprising:
said securing member comprises a rod secured to the inside surface of the lower XZ base and elongate in the Z axis.

23. The system as recited in claim 20, further comprising:
said securing member comprises a steel plate fastened to the under side of the lower XZ base and elongate in the Z axis.

24. The system as recited in claim 20, further comprising:
said securing member comprises a steel plate fastened to the inside surface of the lower XZ base and elongate in the Z axis.

25. The system as recited in claim 20, further comprising:
said securing member comprises a steel U-shaped plate fastened to the under side of the lower XZ base and elongate in the Z axis; and
said steel U-shaped plate having a lower XZ base and two side-walls.

26. The system as recited in claim 19, further comprising:
at least one rib in the lower XZ base; and
said at least one rib elongate in the Z axis.

27. The system as recited in claim 10, further comprising:
an XZ cross-section in the form of an inverted trapezoid;
said trapezoidal cross-section having an XZ base lesser in width to a lower XZ base; and
said trapezoidal cross-section having YZ webs greater in height dimensions to that of the width dimensions of the upper and lower XZ base.

28. The system as recited in claim 27, further comprising:
a structural securing member fastened to the lower XZ surface and elongate in the Z axis.

29. The system as recited in claim 28, further comprising:
said securing member comprises a rod secured to the under side of the lower XZ base and elongate in the Z axis.

30. The system as recited in claim 28, further comprising:
said securing member comprises a rod secured to the inside surface of the lower XZ base and elongate in the Z axis.

31. The system as recited in claim 28, further comprising:
said securing member comprises steel plate fastened to the under side of the lower XZ base and elongate in the Z axis.

32. The system as recited in claim 28, further comprising:
said securing member comprises a steel plate fastened to the inside surface of the lower XZ base and elongate in the Z axis.

33. The system as recited in claim 27, further comprising:
said securing member comprises a steel U-shaped plate fastened to the under side of the lower XZ base and elongate in the Z axis; and
said steel U-shaped plate having a lower XZ base and two side-walls.

34. The system as recited in claim 28, further comprising:
at least one rib in the lower XZ base; and
said at least one rib elongate in the Z axis.

35. The system as recited in claim 1, further comprising:
said first part having an area for screws to secure said first part to said second part; and
said second part having an area for screws to secure said second part to said first part.

36. The system as recited in claim 1, further comprising:
material for said first and second parts comprising steel.

37. The system as recited in claim 1, further comprising:
material for said first and second parts comprising fiberglass.

38. The system as recited in claim 1, further comprising:
said securement flaps recessing into a concrete surface; and
said securement flaps transferring shear force into said concrete.
